(19) United States
(12) Patent Application Publication
(10) Pub. No.: US 2014/0248493 A1
(43) Pub. Date: Sep. 4, 2014

(54) SPHERICAL CARBON MATERIAL AND PROCESS FOR PRODUCING THE SPHERICAL CARBON MATERIAL

(71) Applicant: TODA KOGYO CORP, Otake-shi, Hiroshima-ke (JP)

(72) Inventors: Seiji Okazaki, Otake-shi (JP); Wataru Oda, Otake-shi (JP); Tomoaki Urai, Otake-shi (JP); Akio Sakamoto, Minato-ku (JP)

(73) Assignee: Toda Kogyo Corp., Otake-shi, Hiroshima-ken (JP)

(21) Appl. No.: 14/349,515

(22) PCT Filed: Oct. 2, 2012
(86) PCT No.: PCT/JP2012/075527

§ 371 Date: Apr. 3, 2014

(30) Foreign Application Priority Data
Oct. 4, 2011 (JP) 2011-220554

(51) Int. Cl. H01M 4/587

(52) U.S. Cl. CPC H01M 4/587
USPC 428/402; 264/15

(57) ABSTRACT

The present invention provides a spherical carbon material in the form of isotropic particles which undergoes a considerably less change in shape even after subjected to carbonization or graphitization, and has a good crystal growth property. The present invention relates to a raw coke spherical carbon material in which an average of a plane-direction sphericity and an elevation-direction sphericity of particles of the spherical carbon material as measured in plane and elevation directions of particles of the spherical carbon material, respectively, by observation using a scanning electron microscope is not less than 60%, and a shape retention rate of the spherical carbon material after being heated at 1200° C. for 5 hr and then at 2800° C. for 3 hr is not less than 70%; a process for producing the above raw coke spherical carbon material, comprising the step of applying a compression shear stress to raw coke particles comprising particles having a particle diameter that is not more than 1/3 of an average particle diameter (D50) thereof in an amount of not less than 5% to subject the raw coke particles to dry granulation sphericalization treatment; a carbonaceous spherical carbon material obtained by carbonizing the above raw coke spherical carbon material and a process for producing the carbonaceous spherical carbon material; and a graphite spherical carbon material obtained by graphitizing the above raw coke spherical carbon material and a process for producing the graphite spherical carbon material.

### TECHNICAL FIELD

The present invention relates to a spherical carbon material and a process for producing the same.

### BACKGROUND OF THE INVENTION

In recent years, there is an increasing demand for spherical carbon materials that are used in special carbon material applications or used as a negative electrode material for lithium ion secondary batteries.

In the case of the special carbon materials, it is required that molded products obtained from such carbon materials have an isotropy to enhance a strength thereof. Conventionally, the isotropic special carbon products have been produced by subjecting a molded product prepared by kneading a carbon material with a binder to isostatic molding process such as CIP (cold isostatic pressing) or by conducting a prolonged process in which steps such as calcination and impregnation with pitches, etc., are repeated. Further, recently, there is also an increasing demand for a method of obtaining an isotropic carbon without using the special isotactic molding process. For example, it has been reported that isotropic carbon materials are obtained from MCMB (mesocarbon microbeads) without using any binder (Non-Patent Document 1). However, the reason why the isotropic molded product is obtained from the MCMB as an anisotropic spherical carbon material is considered to be merely that the MCMB can be randomly packed because it is in the form of spherical small particles. Further, since the MCMB is an expensive material, there is a limitation to applications thereof.

As a negative electrode material for lithium ion secondary batteries, the use of a spherical carbon material is required to enhance an electrode density and improve a handling property for increasing a yield thereof at a factory. Further, the use of an isotropic material is required from the standpoint of rate characteristic and service life characteristic of the lithium ion secondary batteries. Also, in the conventional spherical carbon materials such as MCMB, crystal growth thereof tends to hardly proceed when graphitized. Therefore, when using these spherical carbon materials as the negative electrode material for lithium ion secondary batteries, there tends to arise such a problem that the resulting negative electrode material fails to provide a sufficient capacity relative to a theoretical capacity of graphite. The poor crystal growth also tends to cause deterioration in electrical conductivity and thermal conductivity as compared to those of graphite materials having a sufficiently grown crystal structure.

Under these circumstances, at present, there is an increasing demand for an inexpensive crystalline spherical carbon material having an isotropic crystal structure.

In Patent Document 1, there is described a high-density and high-strength isotropic graphite material which is obtained by molding a molding powder prepared by kneading a raw coke and a pitch-based binder and calcining the resulting molded product to graphitize the molding powder. However, the molding powder used as a raw material for the molding product exhibits no isotropy, and therefore it is required to subject the molding material to isostatic molding process.

In Patent Document 2, there is described a graphite material having an aspect ratio of 1.00 to 1.32 which is prepared by subjecting a raw coke to pulverization and graphitization. However, in the course of carbonization and graphitization processes, the particles are formed into a flat shape, thereby failing to obtain spherical particles.

In Patent Document 3, there are described carbon particles whose section has a roundness of 0.6 to 0.9. However, since graphite particles are subjected to mechanical treatment in order to enhance a roundness thereof, the resulting particles have linear portions or angular portions on a contour of the section of the respective particles, and therefore the shape thereof is deviated from a spherical shape. In addition, in order to impart an isotropy to the molded product, it is required to subject the molded product to isostatic pressing treatment.

### CITATION LIST

### Patent Literature

Patent Document 1: Japanese Patent Application Laid-Open (KOKAI) No. 2005-298231
Patent Document 2: Japanese Patent Application Laid-Open (KOKAI) No. 2007-172901
Patent Document 3: Japanese Patent Application Laid-Open (KOKAI) No. 2009-238584
Non-Patent Document 1: Hiroyuki Fujimoto, “THE INDUSTRIAL PRODUCTION METHOD OF MESOCARBON MICROBEADS AND THEIR APPLICATIONS”, “TANSO”, The Carbon Society of Japan, Vol. 2010, No. 241, pp. 10-14

### SUMMARY OF THE INVENTION

### Problem to be Solved by the Invention

An object of the present invention is to obtain a spherical carbon material having an isotropic crystal structure which is capable of maintaining a spherical particle shape even after being subjected to carbonization or graphitization.

### Means for the Solution of the Subject

The above object or technical task can be achieved by the following aspects of the present invention.

That is, according to the present invention, there is provided a raw coke spherical carbon material in which an average of a plane-direction sphericity and an elevation-direction sphericity of particles of the spherical carbon material as measured in plane and elevation directions of the particles, respectively, by observation using a scanning electron microscope is not less than 60%, and a shape retention rate of the spherical carbon material after being heated at 1200° C. for 5 hr and then at 2800° C. for 3 hr is not less than 70% (Invention 1).

Also, according to the present invention, there is provided a carbonaceous spherical carbon material in which an average of a plane-direction sphericity and an elevation-direction sphericity of particles of the spherical carbon material as measured in plane and elevation directions of the particles, respectively, by observation using a scanning electron microscope is not less than 55%, and a shape retention rate of the spherical carbon material after being heated at 2800° C. for 3 hr is not less than 70% (Invention 2).

Also, according to the present invention, there is provided a graphite spherical carbon material in which an average of a plane-direction sphericity and an elevation-direction sphericity of particles of the spherical carbon material as measured in plane and elevation directions of the particles, respectively, by observation using a scanning electron microscope is not less than 50%, and a proportion of an area of crystal domains having the same crystal orientation as observed by a transmission electron microscope is not more than 80% (Invention 3).

In addition, according to the present invention, there is provided a process for producing the raw coke spherical carbon material as described in the above Invention 1, comprising the step of:

applying a compression shear stress to raw coke particles comprising particles having a particle diameter that is not more than ⅓ of an average particle diameter (D50) thereof in an amount of not less than 5% to subject the raw coke particles to dry granulation sphericalization treatment (Invention 4).

Further, according to the present invention, there is provided a process for producing the carbonaceous spherical carbon material as described in the above Invention 2, comprising the steps of:

applying a compression shear stress to raw coke particles comprising particles having a particle diameter that is not more than ⅓ of an average particle diameter (D50) thereof in an amount of not less than 5% to subject the raw coke particles to dry granulation sphericalization treatment; and

carbonizing the resulting raw coke spherical carbon material (Invention 5).

Furthermore, according to the present invention, there is provided a process for producing the graphite spherical carbon material as described in the above Invention 3, comprising the steps of:

applying a compression shear stress to raw coke particles comprising particles having a particle diameter that is not more than ⅓ of an average particle diameter (D50) thereof in an amount of not less than 5% to subject the raw coke particles to dry granulation sphericalization treatment; and

graphitizing the resulting raw coke spherical carbon material (Invention 6).

### Effect of the Invention

The raw coke spherical carbon material according to the present invention is capable of maintaining a spherical particle shape thereof even after subjected to carbonization and/or graphitization, and a carbon molded product obtained from the raw coke spherical carbon material can exhibit a high strength.

The carbonaceous spherical carbon material according to the present invention is capable of maintaining a spherical particle shape thereof even after subjected to graphitization, and a carbon molded product obtained from the carbonaceous spherical carbon material can exhibit a high strength. In addition, the carbonaceous spherical carbon material according to the present invention is in the form of particles having a spherical isotropic crystal structure and therefore can be suitably used as a negative electrode material for lithium ion secondary batteries.

The graphite spherical carbon material according to the present invention is in the form of particles having a spherical isotropic crystal structure, and therefore a carbon molded product obtained from the graphite spherical carbon material can exhibit a high strength. In addition, the graphite spherical carbon material according to the present invention is in the form of particles having a spherical isotropic crystal structure and therefore can be suitably used as a negative electrode material for lithium ion secondary batteries.

Further, in the process for producing a spherical carbon material according to the present invention, it is possible to use an inexpensive material, the carbon material can be produced in a shorted step, and the resulting particles themselves are isotropic, so that no additional steps are required upon molding, which is advantageous in view of economy.

### BRIEF DESCRIPTION OF THE DRAWING

FIG. 1 is a scanning electron micrograph of a raw coke spherical carbon material obtained in Example 1-1 as viewed in a plane direction thereof.

FIG. 2 is a scanning electron micrograph of the raw coke spherical carbon material obtained in Example 1-1 as viewed in an elevation direction thereof.

FIG. 3 is a scanning electron micrograph of a graphite spherical carbon material obtained in Example 3-1 as viewed in a plane direction thereof.

FIG. 4 is a scanning electron micrograph of the graphite spherical carbon material obtained in Example 3-1 as viewed in an elevation direction thereof.

FIG. 5 is a scanning electron micrograph of a raw coke spherical carbon material obtained in Comparative Example 1-2 as viewed in a plane direction thereof.

FIG. 6 is a scanning electron micrograph of the raw coke spherical carbon material obtained in Comparative Example 1-2 as viewed in an elevation direction thereof.

FIG. 7 is a scanning electron micrograph of a graphite spherical carbon material obtained in Comparative Example 3-2 as viewed in a plane direction thereof.

FIG. 8 is a scanning electron micrograph of the graphite spherical carbon material obtained in Comparative Example 3-2 as viewed in an elevation direction thereof.

### PREFERRED EMBODIMENTS FOR CARRYING OUT THE INVENTION

The spherical carbon material according to the present invention is explained below. First, the raw coke spherical carbon material according to the present invention is described.

The raw coke spherical carbon material according to the present invention preferably has an average particle diameter (D50; as measured by a laser scattering method) of 2 to 50 μm. If it is intended to produce a spherical carbon material having an average particle diameter of less than 2 μm by the production process of the present invention, a huge amount of energy tends to be required for pulverizing the material, resulting in unpractical process. When the raw coke spherical carbon material is in the form of particles having an average particle diameter of more than 50 μm, a molded product or a membrane obtained therefrom tends to fail to comprise a sufficient amount of particles well oriented therein, so that when using the carbon material as a molding material, the resulting molded product tends to fail to have a high strength. In view of a good handling property of the particles, the average particle diameter of the raw coke spherical carbon material is more preferably 7 to 30 μm.

The BET specific surface area of the raw coke spherical carbon material according to the present invention may vary depending upon a particle size thereof, and is preferably 0.2 to 10 m²/g. When the BET specific surface area of the raw coke spherical carbon material is more than 10 m²/g, the handling property of the resulting particles tends to be adversely affected. In addition, the raw coke spherical carbon material having a BET specific surface area of more than 10 m²/g tends to be hardly subjected to sufficient sphericalization treatment, so that when subjected to carbonization or graphitization, the particle shape of the carbon material tends to be undesirably thinned. The BET specific surface area of the raw coke spherical carbon material is more preferably 0.3 to 5.0 m²/g.

In the raw coke spherical carbon material according to the present invention, the average of a plane-direction sphericity and an elevation-direction sphericity of particles of the raw coke spherical carbon material is not less than 60%. When the average of the plane-direction sphericity and the elevation-direction sphericity of the particles of the raw coke spherical carbon material is less than 60%, the resulting carbon material tends to fail to be sufficiently granulated, so that when subjected to carbonization or graphitization, the growth of a hexagonal network flat plate crystal structure tends to proceed, resulting in thinned particle shape, i.e., a crystallinity having a strong anisotropy. In view of an isotropy of the crystals, a higher sphericity of the raw coke spherical carbon material is preferred. However, if it is intended to produce particles having an excessively high sphericity, there tends to occur the problem concerning increase in production costs. Therefore, when using the raw coke spherical carbon material in the applications of special carbon materials, the average of the plane-direction sphericity and the elevation-direction sphericity of the particles of the raw coke spherical carbon material is preferably 80 to 90%. On the other hand, when using the raw coke spherical carbon material as a negative electrode material for lithium ion secondary batteries, if the sphericity of the raw coke spherical carbon material is excessively high, the spherical carbon material subjected to carbonization or graphitization also tends to have an excessively high sphericity, so that contact points between the particles tend to be reduced. As a result, there tends to arise the problem of poor rate characteristic of the resulting batteries, and growth of the crystals tends to be insufficient, resulting in deteriorated capacity of the batteries. For this reason, the average of the plane-direction sphericity and the elevation-direction sphericity of the particles of the raw coke spherical carbon material is preferably 60 to 80%.

Meanwhile, the terms “plane direction” and “elevation direction” as used herein are defined as follows. That is, in the case where the shape of particles is photographed by a scanning electron microscope, the direction of the particles observed when the particles present on a base plate (sample sheet) are photographed from above the base plate is referred to as the “plane direction”, whereas the direction of the particles observed when the particles present on the base plate are photographed from a lateral side of the base plate is referred to as the “elevation direction”. The sphericity of the particles of the raw coke spherical carbon material may be measured by the method described in Examples below (with respect to the below-mentioned carbonaceous spherical carbon material and graphite spherical carbon material, the same measuring method is used).

The raw coke spherical carbon material according to the present invention has a shape retention rate of not less than 70% as measured after heating the material at 1200° C. for 5 hr and then at 2800° C. for 3 hr in an inert gas. The spherical carbon material having a shape retention rate of less than 70% tends to suffer from a thinned particle shape when subjected to carbonization or graphitization, and tends to exhibit a strong anisotropic crystal structure. The shape retention rate of the raw coke spherical carbon material is preferably not less than 80%. Meanwhile, the definition and measuring method of the shape retention rate are described in Examples below.

Next, the carbonaceous spherical carbon material according to the present invention is described.

The carbonaceous spherical carbon material according to the present invention preferably has an average particle diameter (D50; as measured by a laser scattering method) of 2 to 50 μm. If it is intended to produce a spherical carbon material having an average particle diameter of less than 2 μm by the production process of the present invention, a huge amount of energy tends to be required for pulverizing the material, resulting in unpractical process. When the spherical carbon material is in the form of particles having an average particle diameter of more than 50 μm, a molded product or a membrane obtained therefrom tends to fail to comprise a sufficient amount of particles well oriented therein, so that when using the carbon material as a molding material, the resulting molded product tends to fail to have a high strength. In view of a good handling property of the particles, the average particle diameter of the carbonaceous spherical carbon material is more preferably 7 to 30 μm.

In the carbonaceous spherical carbon material according to the present invention, the average of a plane-direction sphericity and an elevation-direction sphericity of particles of the carbonaceous spherical carbon material is not less than 55%. When the average of the plane-direction sphericity and the elevation-direction sphericity of the particles of the carbonaceous spherical carbon material is less than 55%, the resulting carbon material tends to fail to be sufficiently granulated, or the particle shape tends to be thinned in the course of carbonization thereof. When such a material is subjected to graphitization, the growth of a hexagonal network flat plate crystal structure tends to further proceed, resulting in thinned particle shape, i.e., a crystallinity having a strong anisotropy. In view of an isotropy of the crystals, a higher sphericity of the carbonaceous spherical carbon material is preferred. However, if it is intended to produce particles having an excessively high sphericity, there tends to occur the problem concerning increase in production costs. Therefore, when using the carbonaceous spherical carbon material in the applications of special carbon materials, the average of the plane-direction sphericity and the elevation-direction sphericity of the particles of the carbonaceous spherical carbon material is preferably 80 to 90%. On the other hand, when using the carbonaceous spherical carbon material as a negative electrode material for lithium ion secondary batteries, if the sphericity of the carbonaceous spherical carbon material is excessively high, the spherical carbon material subjected to graphitization also tends to have an excessively high sphericity, so that contact points between the particles tend to be reduced. As a result, there tends to arise the problem of poor rate characteristic of the resulting batteries, and growth of the crystals tends to be insufficient, resulting in deteriorated capacity of the batteries. For this reason, the average of the plane-direction sphericity and the elevation-direction sphericity of the particles of the carbonaceous spherical carbon material is preferably 55 to 80%.

The carbonaceous spherical carbon material according to the present invention has a shape retention rate of not less than 70% as measured after heating the material at 2800° C. for 3 hr in an inert gas. The spherical carbon material having a shape retention rate of less than 70% tends to suffer from thinned particle shape when subjected to graphitization, and tends to exhibit a strong anisotropic crystal structure. The shape retention rate of the carbonaceous spherical carbon material is preferably not less than 80%. Meanwhile, the definition and measuring method of the shape retention rate are described in Examples below.

Next, the graphite spherical carbon material according to the present invention is described.

The graphite spherical carbon material according to the present invention preferably has an average particle diameter (D50; as measured by a laser scattering method) of 2 to 50 μm. If it is intended to produce a spherical carbon material having an average particle diameter of less than 2 μm by the production process of the present invention, a huge amount of energy tends to be required for pulverizing the material, resulting in unpractical process. When the spherical carbon material is in the form of particles having an average particle diameter of more than 50 μm, a molded product or a membrane obtained therefrom tends to fail to comprise a sufficient amount of particles well oriented therein, so that when using the carbon material as a molding material, the resulting molded product tends to fail to have a high strength. Also, when applying the carbon material to an electrode as a negative electrode material for lithium ion secondary batteries, short circuit tends to be caused. In view of a good handling property of the particles and formation of recent thin layer electrodes, the average particle diameter of the graphite spherical carbon material is more preferably 7 to 30 μm.

The BET specific surface area of the graphite spherical carbon material according to the present invention may vary depending upon a particle size thereof, and is preferably 0.2 to 10 m²/g. When the BET specific surface area of the graphite spherical carbon material is more than 10 m²/g, the handling property of the resulting particles tends to be adversely affected. In particular, when using the carbon material as a negative electrode material for lithium ion secondary batteries, increase in irreversible capacity tends to be induced owing to reduction reaction of an electrolyte solution on the surface of the electrode, resulting in deterioration in initial efficiency of the resulting batteries. On the other hand, if it is intended to obtain the carbon material having a BET specific surface area of less than 0.2 m²/g, since such a material belongs to substantially complete spherical particles, the production of such a carbon material tends to be unpractical from the physical viewpoint and in view of production costs. The BET specific surface area of the graphite spherical carbon material is more preferably 0.3 to 5.0 m²/g.

In the graphite spherical carbon material according to the present invention, the average of a plane-direction sphericity and an elevation-direction sphericity of particles of the graphite spherical carbon material is not less than 50%. When the average of the plane-direction sphericity and the elevation-direction sphericity of the particles of the graphite spherical carbon material is less than 50%, the resulting carbon material tends to fail to be sufficiently granulated, or the shape of the particles tends to be thinned, so that the particles tend to exhibit an undesirable crystal structure having a strong anisotropy. In view of an isotropy of the crystals, a higher sphericity of the graphite spherical carbon material is preferred. However, if it is intended to produce particles having an excessively high sphericity, there tends to occur the problem concerning increase in production costs. Therefore, when using the graphite spherical carbon material in the applications of special carbon materials, the average of the plane-direction sphericity and the elevation-direction sphericity of the particles of the graphite spherical carbon material is preferably 80 to 90%. On the other hand, when using the graphite spherical carbon material as a negative electrode material for lithium ion secondary batteries, if the sphericity of the graphite spherical carbon material is excessively high, contact points between the particles tend to be reduced. As a result, there tends to arise the problem of poor rate characteristic of the resulting batteries, and growth of the crystals tends to be insufficient, resulting in deteriorated capacity of the batteries. For this reason, the average of the plane-direction sphericity and the elevation-direction sphericity of the particles of the graphite spherical carbon material is preferably 50 to 70%.

In the graphite spherical carbon material according to the present invention, the proportion of an area of crystal domains having the same crystal orientation as observed by a transmission electron microscope is not more than 80%. When the crystal domains having the same crystal orientation are present in an amount of more than 80%, the resulting particles tend to be hardly regarded as isotropic particles. The proportion of an area of crystal domains having the same crystal orientation in the graphite spherical carbon material is preferably 10 to 75% and more preferably 40 to 60%.

The spherical carbon material according to the present invention even as one particle has an isotropic crystal structure, i.e., a crystal plane thereof is oriented randomly and no specific crystal plane is grown. Therefore, the spherical carbon material is likely to have an isotropic crystal structure.

Next, the process for producing the spherical carbon material according to the present invention is explained.

In the present invention, as a carbon raw material, there may be used petroleum-based or coal-based raw coke particles, specifically, any of mosaic coke, needle coke and the like. The raw coke means a coke comprising volatile components which is obtained by heating a petroleum-based or coal-based heavy oil at a temperature of about 300 to about 700° C. using a coking facility such as a delayed coker to subject the heavy oil to pyrolysis and polycondensation reaction.

The raw coke particles used as the carbon raw material in the present invention comprise particles having a particle diameter that is not more than ⅓ of an average particle diameter (D50) thereof in an amount of not less than 5%. The raw coke particles preferably comprise particles having a particle diameter that is not more than ⅓ of an average particle diameter (D50) thereof in an amount of 10 to 30%. The particles having a particle diameter that is more than ⅓ of an average particle diameter (D50) thereof are those particles capable of serving as a core upon granulation thereof. Therefore, when the raw coke particles comprise particles having a particle diameter that is not more than ⅓ of an average particle diameter (D50) thereof in an amount of less than 5%, the amount of the particles to be adhered to and combined with core particles tends to be insufficient, so that the raw coke particles tend to be hardly subjected to sphericalization to a sufficient extent. When the raw coke particles comprise particles having a particle diameter that is not more than ⅓ of an average particle diameter (D50) thereof in an amount of more than 30%, the content of the particles acting as core particles tends to be reduced, so that although granulation between fine particles is caused, it may be difficult to obtain spherical particles having a desired particle diameter.

In addition, in the process for producing the carbon material according to the present invention, there may be used such a method in which while granulating the raw coke particles having the above particle size distribution, fine particles of the raw coke are further added thereto. In this case, the amount of the fine particles of the raw coke subsequently added may be controlled so as not to inhibit granulation of the raw coke particles, and therefore the content of the particles having a particle diameter that is not more than ⅓ of an average particle diameter (D50) of the raw coke particles is not limited to not more than 30% based on the amount of the raw coke particles present upon an initial stage of the granulation.

The average particle diameter of the raw coke particles used as the carbon raw material in the present invention is preferably not more than 30 μm. The reason therefor is as follows. That is, if the raw coke particles having an average particle diameter of more than 30 μm are subjected to dry granulation to obtain sufficiently spherical particles, the resulting particles tend to have a particle diameter larger than that of the optimum particles as aimed. The average particle diameter of the raw coke particles is more preferably 5 to 30 μm. The reason therefor is that if the average particle diameter of the raw coke particles is less than 5 μm, sufficient mechanical energy tends to be hardly applied to the particles upon the dry granulation thereof.

In the present invention, by using the raw coke particles having the above particle size distribution and applying a strong shear force thereto, the granulation and sphericalization of the particles can be promoted. Further, the spherical carbon material according to the present invention can maintain a spherical particle shape even after subjected to carbonization or graphitization.

When such raw coke particles are subjected to sphericalization treatment by applying a compression stress and a shear stress thereto, it is possible to obtain the spherical carbon materials according to the present invention. At this time, in addition to the compression stress and shear stress, there also occur impact, friction, rheological stress, etc. The mechanical energy owing to these stresses is larger than an energy applied by ordinary agitation. Therefore, when the strong mechanical energy is applied onto the surface of the respective particles, the effect of causing a so-called mechanochemical phenomenon such as sphericalization of the particle shape and formation of composite particles can be exhibited.

In order to apply the mechanical energy for causing the mechanochemical phenomenon to the raw coke particles, there may be used an apparatus capable of applying stresses such as shear, compression, impact, etc., thereto at the same time, and the structure and principle of the apparatus are not particularly limited. Examples of the apparatus include a ball-type kneader such as a rotary ball mill, a wheel-type kneader such as an edge runner, “Hybridization System” manufactured by Nara Machinery Co., Ltd., “Mechano-Fusion” manufactured by Hosokawa Micron Corp., “NOBILTA” manufactured by Hosokawa Micron Corp., and “COMPOSI” manufactured by Nippon Coke & Engineering, Co., Ltd.

The production conditions in the step of applying a compression shear stress to the raw coke particles may vary depending upon the apparatus used, and there may be used the apparatus having such a structure that consolidation or compression stress is applied to the particles between a rotating blade and a housing thereof.

In the case of using “COMPOSI” manufactured by Nippon Coke & Engineering, Co., Ltd., a peripheral speed and a treating time thereof are preferably adjusted to 50 to 100 m/s and 10 to 180 min, respectively. When the peripheral speed is less than 50 m/s or the treating time is less than 10 min, it is not possible to apply a sufficient compression shear stress to the raw coke particles. On the other hand, when the treating time is more than 180 min, the production costs tend to be increased, which is disadvantageous in supply of an inexpensive carbon material.

In the case of using the “Hybridization System” (manufactured by Nara Machinery Co., Ltd.), it is preferred that a peripheral speed and a treating time thereof are adjusted to 40 to 80 m/s and 5 to 180 min, respectively, in order to apply a sufficient compression shear stress to the raw coke particles.

Also, the control temperature used upon the treatment of applying a compression shear stress to the raw coke particles is preferably 60 to 400° C., in particular, the control temperature upon the treatment is more preferably 150 to 350° C.

The treatment of applying a compression stress and a shear stress to the raw coke particles is such a treatment that particles having a small particle diameter are deposited on the surface of particles acting as a core to form composite particles by using a mechanochemical reaction therebetween, i.e., such a treatment that the shape of the core particles is sphericalized while absorbing fine particles thereon. Therefore, the treatment is accompanied with neither generation of fine particles nor pulverization for reducing the particle size. The raw coke comprises volatile components and therefore exhibits adhesiveness. However, the adhesiveness of the raw coke has a suitable effect of facilitating instantaneous deposition of abraded pieces thereof on the particles.

In the present invention, the above obtained raw coke spherical carbon material is subjected to carbonization treatment to thereby obtain a carbonaceous spherical carbon material.

The carbonization method is not particularly limited. There may be usually used the method in which the raw coke spherical carbon material is subjected to heat treatment in an inert gas atmosphere such as nitrogen, argon and helium under the condition that the maximum temperature to be reached is 800 to 1600° C., and the retention time at the maximum temperature is 0 to 10 hr.

In the present invention, the above obtained raw coke spherical carbon material or carbonaceous spherical carbon material is subjected to graphitization treatment to thereby obtain a graphite spherical carbon material.

The graphitization treatment method is not particularly limited. There may be usually used the method in which the raw coke spherical carbon material or carbonaceous spherical carbon material is subjected to heat treatment in an inert gas atmosphere such as nitrogen, argon and helium under the condition that the maximum temperature to be reached is 2000 to 3200° C., and the retention time at the maximum temperature is 0 to 100 hr.

In general, a graphite material heat-treated at a graphitization temperature of not lower than 2800° C. undergoes promoted crystallization, and therefore has a strongly anisotropic crystal structure. A lithium ion secondary battery obtained using a negative electrode formed of such a graphite material has a large capacity, but an electrolyte solution is likely to be decomposed owing to co-insertion of the solvent, resulting in deteriorated service life characteristic of the battery. However, the spherical carbon material according to the present invention has not a merely highly grown crystal structure, but a strong isotropic crystal structure, in particular, on the surface of the respective particles, so that the increase in irreversible capacity owing to promoted reducing reaction in the crystal structure is suppressed, as compared to a negative electrode material obtained merely by using a coke material as a raw material. Further, owing to the isotropic crystal structure, the use of the spherical carbon material according to the present invention advantageously acts on rate characteristic and service life characteristic of the resulting secondary battery. As a result, the obtained secondary battery is capable of exhibiting both of a high capacity and a high service life characteristic.

That is, the raw coke spherical carbon material according to the present invention is capable of maintaining a spherical particle shape even after being subjected to carbonization or graphitization, and the carbon molded product produced by using the raw coke spherical carbon material can exhibit a high strength.

The carbonaceous spherical carbon material according to the present invention is capable of maintaining a spherical particle shape even after being subjected to graphitization, and the carbon molded product produced by using the carbonaceous spherical carbon material can exhibit a high strength. In addition, the carbonaceous spherical carbon material according to the present invention is in the form of particles having a spherical isotropic crystal structure, and therefore can also be suitably used as a negative electrode material for lithium ion secondary batteries.

The graphite spherical carbon material according to the present invention is in the form of particles having a spherical isotropic crystal structure, and therefore the carbon molded product produced by using the graphite spherical carbon material can exhibit a high strength. In addition, the graphite spherical carbon material according to the present invention is in the form of particles having a spherical isotropic crystal structure, and therefore can also be suitably used as a negative electrode material for lithium ion secondary batteries.

### EXAMPLES

The average particle diameter of each of the raw coke as a raw material and the spherical carbon material was measured using a laser scattering type particle size distribution measuring device “LMS-2000e” manufactured by Malvern Instruments Ltd.

The BET specific surface area was measured using “MULTISORB” manufactured by Malvern Instruments Ltd.

The sphericity of the particles was determined as follows. That is, the particles were applied onto a sheet such that they were not overlapped on each other and a flat surface of the flattened particles was oriented in parallel with a surface of the sheet, and the sheet to which the particles had been applied was photographed in a plane direction or an elevation direction thereof using a scanning electron microscope (“S-4800” manufactured by Hitachi High-Technologies Corp.). From the images thus photographed, an average value of sphericity values of 300 particles each calculated from the following formula was obtained.

Sphericity(%)=(projected area of particle/area of minimum circumscribed circle of projected image of particle)×100

Further, in the present invention, by using the average value of the sphericity in the plane direction of the particles and the sphericity in the elevation direction of the particles, the spherical carbon material that may be generally readily flattened when subjected to carbonization or graphitization was evaluated three-dimensionally.

The shape retention rate of the particles was determined as follows. That is, the particles were applied onto a sheet such that they were not overlapped on each other and a flat surface of the flattened particles was oriented in parallel with a surface of the sheet, and the sheet on which the particles had been applied was photographed in an elevation direction thereof using a scanning electron microscope. The shape retention rate of the particles was calculated from an average value of ratio (minimum width/maximum length) values of the 300 particles each measured by analyzing the image thus photographed, according to the following formula.

Shape retention rate(%)=(minimum width/maximum length of particles after heated)/(minimum width/maximum length of particles before heated)×100

The crystal orientation was evaluated from an area of crystal domains having the same crystal orientation by dark field observation using a transmission electron microscope “HD-2000” manufactured by Hitachi High-Technologies Corp. The area of crystal domains having the same crystal orientation was determined as follows. That is, graphite particles were abraded by a focused ion beam to photograph a dark-field image of a section of the abraded particles (gray scale images of 256 gradations) using a transmission electron microscope. The randomly selected five dark-field images were binarized based on 100 as a threshold value to obtain an average value thereof.

In the dark-field observation using a transmission electron microscope, electron beam undergoes diffraction when passing through a sample to form an image whereby it is possible to measure a crystal orientation thereof. In the dark-field image, diffracted portions, i.e., crystal domains having the same crystal orientation are observed as light portions, whereas the other portions are observed as very dark portions.

The graphite spherical carbon material according to the present invention was used as a negative electrode material to produce a lithium ion secondary battery.

### <Production of Positive Electrode>

A metallic lithium foil was blanked into 16 mmφ to produce a positive electrode.

### <Production of Negative Electrode>

A negative electrode active substance was prepared by mixing 94% by weight of the graphite spherical carbon material according to the present invention, 2% by weight of acetylene black as a conducting material, 2% by weight of a styrene-butadiene rubber as a binder and 2% by weight of carboxymethyl cellulose as a thickening agent in a water solvent, applied onto a copper foil and then dried at 120° C. The resulting sheets were blanked into 16 mmφ and compression-bonded to each other by applying a pressure of 1.5 t/cm² thereto to thereby produce a negative electrode.

### <Assembly of Coin Cell>

In a glove box held in an argon atmosphere, the above positive electrodes and negative electrodes were alternately stacked via a polypropylene separator in an SUS316L case, and further an electrolyte solution prepared by mixing EC and DMC in which 1 mol/L LiPF₆ was dissolved, at a volume ratio of 1:2 was poured into the case, thereby producing a 2032 type coin cell.

### <Evaluation of Battery>

The above produced coin cell was subjected to charge/discharge test for secondary batteries. Specifically, in a thermostat maintained at 25° C., the coin cell was subjected to 5 charge/discharge cycles at ⅕C under a cut-off voltage in the range of 0.01 to 1.5 V, and a discharge capacity at the 5th cycle was measured as a reversible capacity.

### Example 1-1

Needle coke was pulverized and classified to prepare raw coke particles having an average particle diameter of 10 μm and comprising fine particles having a particle diameter being not more than ⅓ of the average particle diameter in an amount of 12%. The thus prepared raw coke particles were subjected to sphericalization treatment using “COMPOSI CP15 Model” manufactured by Nippon Coke & Engineering Co., Ltd., at 150° C. at a peripheral speed of 80 m/s for 120 min, and then particles having a particle diameter of not more than 7 μm were removed from the above particles by classification using an air classifier, thereby obtaining a raw coke spherical carbon material.

The properties of the resulting raw coke spherical carbon material are shown in Table 1.

### Example 1-2

Needle coke was pulverized and classified to prepare raw coke particles having an average particle diameter of 7 μm and comprising fine particles having a particle diameter being not more than ⅓ of the average particle diameter in an amount of 10%. The thus prepared raw coke particles were subjected to sphericalization treatment using “COMPOSI CP130 Model” manufactured by Nippon Coke & Engineering Co., Ltd., at 340° C. at a peripheral speed of 90 m/s for 60 min, and then particles having a particle diameter of not more than 3 μm were removed from the above particles by classification using an air classifier, thereby obtaining a raw coke spherical carbon material.

### Example 1-3

Mosaic coke was pulverized and classified to prepare raw coke particles having an average particle diameter of 6.4 μm and comprising fine particles having a particle diameter being not more than ⅓ of the average particle diameter in an amount of 10%. The thus prepared raw coke particles were subjected to sphericalization treatment using “COMPOSI CP130 Model” manufactured by Nippon Coke & Engineering Co., Ltd., at 240° C. at a peripheral speed of 90 m/s for 75 min, and then particles having a particle diameter of not more than 3 μm were removed from the above particles by classification using an air classifier, thereby obtaining a raw coke spherical carbon material.

### Example 1-4

Needle coke was pulverized and classified to prepare raw coke particles having an average particle diameter of 7 μm and comprising fine particles having a particle diameter being not more than ⅓ of the average particle diameter in an amount of 20%. The thus prepared raw coke particles were subjected to sphericalization treatment using “Hybridization System NHS-1 Model” manufactured by Nara Machinery Co., Ltd., at 65° C. at a peripheral speed of 60 m/s for 20 min, and then particles having a particle diameter of not more than 3 μm were removed from the above particles by classification using an air classifier, thereby obtaining a raw coke spherical carbon material.

### Example 1-5

Needle coke was pulverized and classified to prepare raw coke particles having an average particle diameter of 10 μm and comprising fine particles having a particle diameter being not more than ⅓ of the average particle diameter in an amount of 12%. The thus prepared raw coke particles were subjected to sphericalization treatment using “COMPOSI CP130 Model” manufactured by Nippon Coke & Engineering Co., Ltd., at 230° C. at a peripheral speed of 80 m/s for 60 min, and then particles having a particle diameter of not more than 5 μm were removed from the above particles by classification using an air classifier, thereby obtaining a raw coke spherical carbon material.

### Example 1-6

Needle coke was pulverized and classified to prepare raw coke particles having an average particle diameter of 10 μm and comprising fine particles having a particle diameter being not more than ⅓ of the average particle diameter in an amount of 12%. The thus prepared raw coke particles were subjected to sphericalization treatment using “COMPOSI CP130 Model” manufactured by Nippon Coke & Engineering Co., Ltd., at 350° C. at a peripheral speed of 90 m/s for 30 min, and then particles having a particle diameter of not more than 5 μm were removed from the above particles by classification using an air classifier, thereby obtaining a raw coke spherical carbon material.

### Comparative Example 1-1

Needle coke was pulverized and classified to prepare raw coke particles having an average particle diameter of 12 μm and comprising fine particles having a particle diameter being not more than ⅓ of the average particle diameter in an amount of 1%. The thus prepared raw coke particles were subjected to sphericalization treatment using “COMPOSI CP15 Model” manufactured by Nippon Coke & Engineering Co., Ltd., at 170° C. at a peripheral speed of 80 m/s for 120 min, and then particles having a particle diameter of not more than 3 μm were removed from the above particles by classification using an air classifier, thereby obtaining a raw coke spherical carbon material.

### Comparative Example 1-2

Needle coke was pulverized and classified to prepare raw coke particles having an average particle diameter of 12 μm and comprising fine particles having a particle diameter being not more than ⅓ of the average particle diameter in an amount of 1%.

### Comparative Example 1-3

Needle coke was pulverized and classified to prepare raw coke particles having an average particle diameter of 16 μm and comprising fine particles having a particle diameter being not more than ⅓ of the average particle diameter in an amount of 2.5%.

### Comparative Example 1-4

Needle coke was pulverized and classified to prepare raw coke particles having an average particle diameter of 12 μm and comprising fine particles having a particle diameter being not more than ⅓ of the average particle diameter in an amount of 1%. The thus prepared raw coke particles were subjected to sphericalization treatment using “NOBILTA NOB-130 Model” manufactured by Hosokawa Micron Corp., at 50° C. at a peripheral speed of 20 m/s for 30 min, thereby obtaining a raw coke spherical carbon material.

### Comparative Example 1-5

Needle coke was pulverized and classified to prepare raw coke particles having an average particle diameter of 16 μm and comprising fine particles having a particle diameter being not more than ⅓ of the average particle diameter in an amount of 2.5%. The thus prepared raw coke particles were subjected to sphericalization treatment using “NOBILTA NOB-700 Model” manufactured by Hosokawa Micron Corp., at 98° C. at a peripheral speed of 20 m/s for 120 min, thereby obtaining a raw coke spherical carbon material.

### Comparative Example 1-6

Needle coke was pulverized and classified to prepare raw coke particles having an average particle diameter of 16 μm and comprising fine particles having a particle diameter being not more than ⅓ of the average particle diameter in an amount of 2.5%. The thus prepared raw coke particles were subjected to sphericalization treatment using “NOBILTA NOB-130 Model” manufactured by Hosokawa Micron Corp., at 60° C. at a peripheral speed of 20 m/s for 30 min, thereby obtaining a raw coke spherical carbon material.

TABLE 1

| | Raw coke spherical carbon material | | |
|---|---|---|---|
| | Average | | Sphericity |
| Examples and | particle | BET specific | Plane |
| Comparative | diameter | surface area | direction |
| Examples | (μm) | (m²/g) | (%) |
| Example 1-1 | 29.6 | 0.3 | 85.1 |
| Example 1-2 | 9.4 | 3.0 | 68.5 |
| Example 1-3 | 9.6 | 2.0 | 71.2 |
| Example 1-4 | 14.0 | 4.0 | 68.0 |
| Example 1-5 | 17.2 | 1.2 | 75.0 |
| Example 1-6 | 16.6 | 1.7 | 71.4 |
| Comparative | 14.3 | 0.7 | 60.2 |
| Example 1-1 | | | |
| Comparative | 12.0 | 2.7 | 53.4 |
| Example 1-2 | | | |
| Comparative | 16.3 | 1.5 | 58.0 |
| Example 1-3 | | | |
| Comparative | 12.5 | 35.1 | 55.0 |
| Example 1-4 | | | |
| Comparative | 17.1 | 30.0 | 58.7 |
| Example 1-5 | | | |
| Comparative | 24.0 | 32.7 | 59.5 |
| Example 1-6 | | | |

| | Raw coke spherical carbon material | | |
|---|---|---|---|
| | Sphericity | | Shape |
| Examples and | Vertical | | retention |
| Comparative | direction | Average | rate |
| Examples | (%) | (%) | (%) |
| Example 1-1 | 79.9 | 82.5 | 100 |
| Example 1-2 | 62.6 | 65.6 | 79 |
| Example 1-3 | 70.4 | 70.8 | 89 |
| Example 1-4 | 63.0 | 65.5 | 78 |
| Example 1-5 | 67.0 | 71.0 | 87 |
| Example 1-6 | 63.0 | 67.2 | 85 |
| Comparative | 56.4 | 58.3 | 60 |
| Example 1-1 | | | |
| Comparative | 51.6 | 52.5 | 59 |
| Example 1-2 | | | |
| Comparative | 46.0 | 52.0 | 63 |
| Example 1-3 | | | |
| Comparative | 45.0 | 50.0 | 60 |
| Example 1-4 | | | |
| Comparative | 45.5 | 52.1 | 64 |
| Example 1-5 | | | |
| Comparative | 44.3 | 51.9 | 68 |
| Example 1-6 | | | |

The raw coke spherical carbon materials obtained in Examples 1-1 to 1-6 and Comparative Examples 1-1 to 1-6 were respectively subjected to carbonization treatment in an inert gas atmosphere at 1200° C. for 300 min, thereby obtaining carbonaceous spherical carbon materials of Examples 2-1 to 2-6 and Comparative Examples 2-1 to 2-6, respectively. The properties of the resulting carbonaceous spherical carbon materials are shown in Table 2.

TABLE 2

Carbonaceous spherical carbon material

| Examples and | Average particle | Sphericity |
|---|---|---|
| Comparative | diameter | Plane direction |
| Examples | (μm) | (%) |
| Example 2-1 | 27.0 | 85.0 |
| Example 2-2 | 9.1 | 67.0 |
| Example 2-3 | 8.6 | 67.1 |
| Example 2-4 | 12.3 | 65.3 |
| Example 2-5 | 15.5 | 69.3 |
| Example 2-6 | 16.4 | 67.8 |
| Comparative | 13.0 | 62.9 |
| Example 2-1 | | |
| Comparative | 11.7 | 52.0 |
| Example 2-2 | | |
| Comparative | 14.3 | 55.7 |
| Example 2-3 | | |
| Comparative | 12.0 | 53.9 |
| Example 2-4 | | |
| Comparative | 15.8 | 56.5 |
| Example 2-5 | | |
| Comparative | 22.2 | 56.0 |
| Example 2-6 | | |

| | Carbonaceous spherical carbon material | | |
|---|---|---|---|
| | Sphericity | | Shape |
| Examples and | Vertical | | retention |
| Comparative | direction | Average | rate |
| Examples | (%) | (%) | (%) |
| Example 2-1 | 81.0 | 83.0 | 100 |
| Example 2-2 | 52.5 | 59.8 | 97 |
| Example 2-3 | 65.0 | 66.1 | 97 |
| Example 2-4 | 49.5 | 57.4 | 81.4 |
| Example 2-5 | 62.3 | 65.8 | 89.1 |
| Example 2-6 | 61.0 | 64.4 | 89.9 |
| Comparative | 40.1 | 51.5 | 84.6 |
| Example 2-1 | | | |
| Comparative | 33.2 | 42.6 | 87 |
| Example 2-2 | | | |
| Comparative | 39.4 | 47.6 | 77 |
| Example 2-3 | | | |
| Comparative | 34.8 | 44.4 | 80 |
| Example 2-4 | | | |
| Comparative | 37.2 | 46.9 | 81.3 |
| Example 2-5 | | | |
| Comparative | 35.6 | 45.8 | 85.1 |
| Example 2-6 | | | |

Further, the carbonaceous spherical carbon materials obtained in Examples 2-1 to 2-6 and Comparative Examples 2-1 to 2-6 were respectively subjected to graphitization treatment in an inert gas atmosphere at 2800° C. for 60 min, thereby obtaining graphite spherical carbon materials of Examples 3-1 to 3-6 and Comparative Examples 3-1 to 3-6, respectively. The properties of the resulting graphite spherical carbon materials are shown in Table 3.

TABLE 3

| | Graphite spherical carbon material | | |
|---|---|---|---|
| | Average | | Sphericity |
| Examples and | particle | BET specific | Plane |
| Comparative | diameter | surface area | direction |
| Examples | (μm) | (m²/g) | (%) |
| Example 3-1 | 26.4 | 0.3 | 85.0 |
| Example 3-2 | 9.0 | 0.7 | 63.5 |
| Example 3-3 | 8.3 | 0.8 | 65.4 |
| Example 3-4 | 11.0 | 1.0 | 63.0 |
| Example 3-5 | 13.7 | 0.3 | 66.1 |
| Example 3-6 | 16.4 | 0.5 | 65.7 |
| Comparative | 12.0 | 0.5 | 59.6 |
| Example 3-1 | | | |
| Comparative | 11.6 | 1.1 | 51.9 |
| Example 3-2 | | | |
| Comparative | 13.7 | 0.8 | 54.1 |
| Example 3-3 | | | |
| Comparative | 11.7 | 0.9 | 53.0 |
| Example 3-4 | | | |
| Comparative | 15.2 | 0.8 | 55.2 |
| Example 3-5 | | | |
| Comparative | 22.0 | 0.8 | 54.8 |
| Example 3-6 | | | |

| | Graphite spherical carbon material | | |
|---|---|---|---|
| | | | Proportion of area of |
| | Sphericity | | crystal domains having |
| Examples and | Vertical | | the same crystal |
| Comparative | direction | Average | orientation |
| Examples | (%) | (%) | (%) |
| Example 3-1 | 81.1 | 83.1 | 40 |
| Example 3-2 | 49.0 | 56.3 | 70 |
| Example 3-3 | 62.8 | 64.1 | 20 |
| Example 3-4 | 40.0 | 51.5 | 75 |
| Example 3-5 | 55.5 | 60.8 | 60 |
| Example 3-6 | 54.8 | 60.3 | 70 |
| Comparative | 33.3 | 46.5 | 80 |
| Example 3-1 | | | |
| Comparative | 29.8 | 40.9 | 95 |
| Example 3-2 | | | |
| Comparative | 30.5 | 42.3 | 90 |
| Example 3-3 | | | |
| Comparative | 30.0 | 41.5 | 93 |
| Example 3-4 | | | |
| Comparative | 33.0 | 44.1 | 87 |
| Example 3-5 | | | |
| Comparative | 31.1 | 43.0 | 90 |
| Example 3-6 | | | |

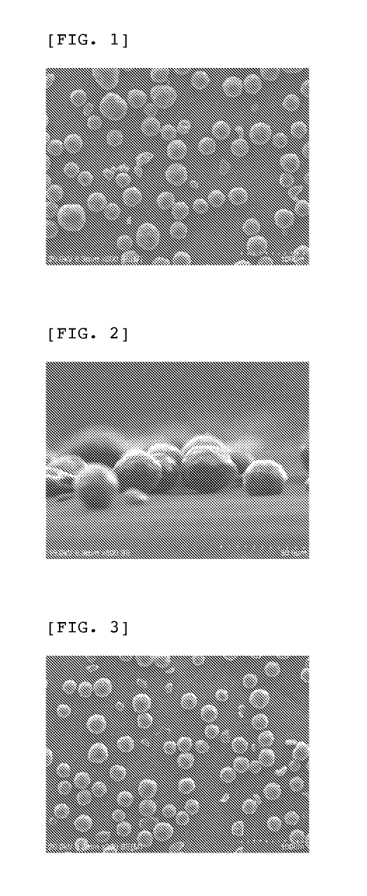

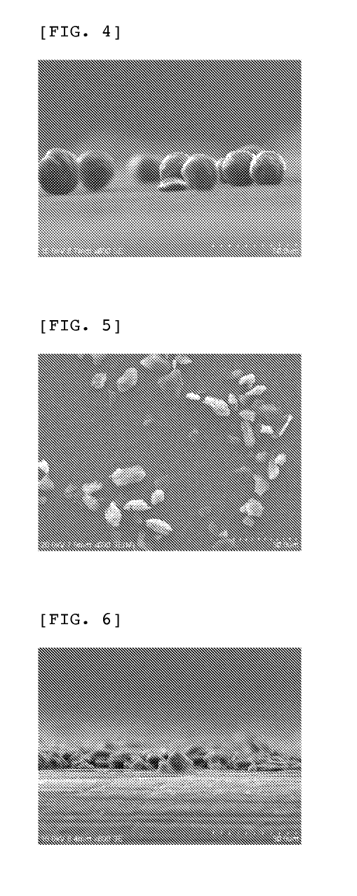

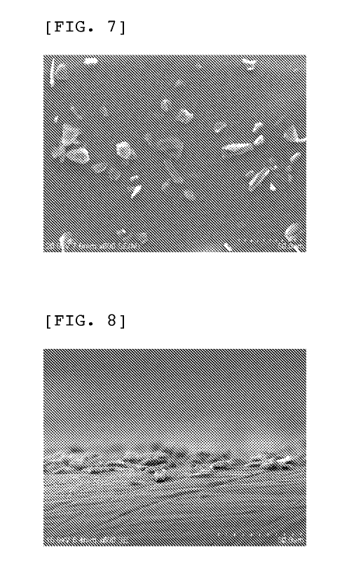

The transmission electron micrograph images of the raw coke spherical carbon material obtained in Example 1-1 and the graphite spherical carbon material obtained in Example 3-1 are shown in FIGS. 1 to 4. The raw coke spherical carbon material obtained in Example 1-1 had a shape retention rate of 100% even after subjected carbonization and graphitization treatments. Therefore, it was recognized that the spherical carbon material according to the present invention was capable of maintaining a spherical particle shape even after subjected to carbonization and graphitization. On the other hand, the raw coke carbon material obtained in Comparative Example 1-2 had a shape retention rate of 59% after subjected to carbonization and graphitization. Therefore, as conventionally reported, there was recognized such a phenomenon that in the case where a coke raw material is subjected to carbonization and graphitization, the growth of a hexagonal network flat plate crystal structure tends to proceed, resulting in thinned particle shape.

The carbon material obtained in Comparative Example 1-1 by subjecting the raw coke particles failing to comprise a sufficient amount of the particles having a particle diameter being not more than ⅓ of an average particle diameter (D50) thereof to sphericalization treatment had a low sphericity as shown in Table 1.

With respect to the crystal orientation of the graphite spherical carbon particles according to the present invention, the proportion of the area of crystal domains having the same crystal orientation is shown in Table 3. The crystal structure of MCMB and a graphitized product thereof is a lamella structure in which molecules are oriented in a predetermined direction (Non-Patent Document 1). On the other hand, the graphite spherical carbon material according to the present invention even as one particle exhibited a characteristic of an isotropic crystal, and therefore it is considered that even when used in the applications of special carbon materials, the resulting material is advantageous in view of its strength.

Also, in the case where the needle coke particles pulverized were directly subjected to graphitization without subjected to sphericalization treatment as in Comparative Examples 1-2 and 1-3, it was recognized that the area of crystal domains having the same crystal orientation became large, and the resulting material therefore exhibited a strong anisotropy. On the other hand, in the case where the carbon material was produced by the production process of the present invention as in Example 1-1, it was recognized that the area of crystal domains having the same crystal orientation was reduced, and the resulting material therefore had a strong isotropic crystal structure.

Also, as shown in Examples 1-2 and 1-3, it was recognized that the production process of the present invention was applicable to even the raw coke materials having a small particle diameter. In general, a finely pulverized coke raw material is likely to cause peeling of flake-like pieces along a grain boundary of the raw material. It is known that when graphitized, such a raw material is converted into a strongly anisotropic material in view of the crystallographic structure. However, according to the production process of the present invention, even the raw coke material having a small particle diameter is capable of providing a carbon material that can maintain a spherical shape even after graphitized.

Further, as shown in Example 1-3, it was recognized that even when using mosaic coke as the raw material, the production process of the present invention can be effectively applied thereto. In general, the mosaic coke is also likely to cause peeling of flake-like particles along crystals thereof when subjected to pulverization or heat treatment. However, according to the production process of the present invention, it is possible to obtain a spherical carbon material having a high sphericity and an extremely high shape retention rate between before and after being subjected to heat treatment.

The graphite spherical carbon materials obtained according to the present invention exhibited a battery reversible capacity of not less than 300 mAh/g, i.e., 334 mAh/g in Example 3-2, 344 mAh/g in Example 3-4, and 322 mAh/g in Example 3-5. As the conventionally existing spherical graphitized carbon, there may be typically mentioned MCMB. However, as described in Non-Patent Document 1, it is generally known that MCMB hardly exhibits a large reversible capacity even when raising a graphitizing temperature for the reason of its properties owing to a production method thereof. The graphite spherical carbon material according to the present invention is in the form of particles having a spherical isotropic crystal structure and therefore can be improved in battery reversible capacity. Thus, the graphite spherical carbon material of the present invention can be suitably used as a negative electrode material for lithium ion secondary batteries.

### INDUSTRIAL APPLICABILITY

In accordance with the present invention, it is possible to obtain a spherical carbon material having an isotropic crystal structure which can be packed with a high density. The spherical carbon material according to the present invention is capable of maintaining a spherical particle shape even after being subjected to carbonization or graphitization, and a carbon molded product obtained using the above carbon material can exhibit a high strength.

In addition, the graphite spherical carbon material according to the present invention is in the form of particles having a spherical isotropic crystal structure and therefore can also be suitably used as a negative electrode active substance for lithium ion secondary batteries.

1. A raw coke spherical carbon material in which an average of a plane-direction sphericity and an elevation-direction sphericity of particles of the spherical carbon material as measured in plane and elevation directions of the particles, respectively, by observation using a scanning electron microscope, is not less than 60%, and a shape retention rate of the spherical carbon material after being heated at 1200° C. for 5 hr and then at 2800° C. for 3 hr is not less than 70%.

2. A carbonaceous spherical carbon material in which an average of a plane-direction sphericity and an elevation-direction sphericity of particles of the spherical carbon material as measured in plane and elevation directions of the particles, respectively, by observation using a scanning electron microscope, is not less than 55%, and a shape retention rate of the spherical carbon material after being heated at 2800° C. for 3 hr is not less than 70%.

3. A graphite spherical carbon material in which an average of a plane-direction sphericity and an elevation-direction sphericity of particles of the spherical carbon material as measured in plane and elevation directions of the particles, respectively, by observation using a scanning electron microscope, is not less than 50%, and a proportion of an area of crystal domains having the same crystal orientation as observed by a transmission electron microscope is not more than 80%.

4. A process for producing the raw coke spherical carbon material as defined in claim 1, comprising the step of:
applying a compression shear stress to raw coke particles comprising particles having a particle diameter that is not more than ⅓ of an average particle diameter (D50) thereof in an amount of not less than 5% to subject the raw coke particles to dry granulation sphericalization treatment.

5. A process for producing the carbonaceous spherical carbon material as defined in claim 2, comprising the steps of:
applying a compression shear stress to raw coke particles comprising particles having a particle diameter that is not more than ⅓ of an average particle diameter (D50) thereof in an amount of not less than 5% to subject the raw coke particles to dry granulation sphericalization treatment; and
carbonizing the resulting raw coke spherical carbon material.

6. A process for producing the graphite spherical carbon material as defined in claim 3, comprising the steps of:
applying a compression shear stress to raw coke particles comprising particles having a particle diameter that is not more than ⅓ of an average particle diameter (D50) thereof in an amount of not less than 5% to subject the raw coke particles to dry granulation sphericalization treatment; and
graphitizing the resulting raw coke spherical carbon material.
